(19) United States
(12) Patent Application Publication
(10) Pub. No.: US 2019/0070717 A1
(43) Pub. Date: Mar. 7, 2019

(54) Hydraulic Adapter for Installing Connecting Flange of Oil Pipe

(71) Applicant: Sichuan Xingzhi Zhihui Intellectual Property Operation Co., Ltd., Chengdu (CN)

(72) Inventor: Changming He, Chengdu (CN)

(21) Appl. No.: 15/539,704

(22) PCT Filed: Oct. 14, 2016
(86) PCT No.: PCT/CN2016/097427

§ 371 Date: Jun. 26, 2017

(30) Foreign Application Priority Data
May 11, 2016 (CN) 201610306348.2

(51) Int. Cl. B25B 27/16; F16L 1/09; F16L 1/10; F16L 23/00

(52) U.S. Cl. CPC B25B 27/16; F16L 1/09; B25B 5/147; F16L 23/003; F16L 1/10

(57) ABSTRACT

A hydraulic adapter for installing connecting flanges of an oil pipe comprises a first centralizer, a second centralizer, and a hydraulic cylinder. Tapered cylinders are disposed on the first centralizer. A first flange centralizing protrusion is disposed on the first centralizer. A hydraulic cylinder installation hole is disposed on the first centralizer between two of the tapered cylinders. Tapered protrusions are disposed on the second centralizer and fit with the tapered cylinders disposed on the first centralizer. An adjustment hole is disposed on the second centralizer. A second flange centralizing protrusion is disposed on the second centralizer. A base of the hydraulic cylinder is disposed on an outer side of the first centralizer, and a hydraulic arm of the hydraulic cylinder perforates through the hydraulic cylinder installation hole and the adjustment hole. An extrusion block is disposed at an end of the hydraulic arm.

### FIELD OF THE INVENTION

The present invention relates to the field of flange connection centralization, and more particularly to a hydraulic adapter for installing connecting flanges of an oil pipe.

### BACKGROUND OF THE INVENTION

In the oil and gas field work site, the use of flanges to connect various kinds of installations or pipelines is the most widely used connection form. Flanges enable workers to finish the work quickly and easily when they are repairing or replacing accessories. At present, in the oil and gas field work site, the use of flanges to connect various valves or other parts is a common way of connection. In the process of production, vibration or oppression by objects of working pipelines or weight of objects connected to the flange of pipelines would cause bending and deformation of the pipelines, leading to different degrees of longitudinal shift of two pieces of flanges at the flanged joints. Therefore, when repairing or replacing accessories, it is difficult for workers to install the connecting flanges. The workers would need to use a crowbar to pry up the flanges to reconnect the two flanges, hence lengthening the maintenance of installing flanges, reducing work efficiency, and affecting the production efficiency.

### BRIEF SUMMARY OF THE INVENTION

The purpose of the present invention is to overcome the shortcomings of existing art. Therefore, the present invention provides a hydraulic adapter for installing connecting flanges of oil pipe that solves the problems of difficult and inaccurate docking of mounting holes of bolts of flanges.

According to an embodiment of the present invention, a hydraulic adapter for installing connecting flanges of an oil pipe comprises a first centralizer, a second centralizer, and a hydraulic cylinder. Tapered cylinders are respectively disposed on an upper portion and a middle portion of an inner side surface of the first centralizer. A first flange centralizing protrusion is disposed on a lower portion of the inner side surface of the first centralizer. A hydraulic cylinder installation hole is disposed on the first centralizer between two of the tapered cylinders. Tapered protrusions are respectively disposed on an upper portion and a middle portion of an inner side surface of the second centralizer and fit with the tapered cylinders disposed on the first centralizer. An adjustment hole is disposed on the second centralizer between two of the tapered protrusions. A second flange centralizing protrusion is disposed on a lower portion of the inner side surface of the second centralizer. A base of the hydraulic cylinder is disposed on an outer side of the first centralizer by utilizing a hydraulic cylinder bracket, and a hydraulic arm of the hydraulic cylinder perforates through the hydraulic cylinder installation hole and the adjustment hole. An extrusion block is disposed at an end of the hydraulic arm.

An oil pipe support is disposed on a lower side of the outer side of the first centralizer and comprises a control panel and an arc shaped pipe rack. The control panel is disposed on the arc shaped pipe rack. A bar adjustment hole is disposed on the control panel, and the oil pipe support are fixed on the first centralizer by inserting an adjusting bolt into the bar adjustment hole.

According to another embodiment of the present invention, a handle frame is disposed on the first centralizer.

According to another embodiment of the present invention, a handle frame is disposed on the second centralizer.

According to another embodiment of the present invention, a centralizing tapered cylinder is disposed at the end of the first flange centralizing protrusion, and a centralizing tapered protrusion is disposed at the end of the second flange centralizing protrusion. The centralizing tapered cylinder fits with the centralizing tapered protrusion.

According to another embodiment of the present invention, a centralizing tapered protrusion is disposed at the end of the first flange centralizing protrusion, and a centralizing tapered cylinder is disposed at the end of the second flange centralizing protrusion. The centralizing tapered cylinder fits with the centralizing tapered protrusion.

According to another embodiment of the present invention, the adjusting bolt comprises an adjusting hand wheel, a screw and a locking ring. The adjusting hand wheel is disposed on the end of the screw, and the locking ring is fixed on the screw.

As compared with the existing art, the present invention has the following advantages and beneficial effects:

1. By utilizing the fitting of the tapered cylinder and tapered protrusion, the first flange centralizing protrusion on the first centralizer and the second flange centralizing protrusion on the second centralizer can be docked precisely, allowing the two deviated flanged holes to be fully docked and therefore facilitating installation of the bolts;

2. The handle frames are disposed on the first centralizer and the second centralizer for facilitating centralization of docking of flanges in oil pipe connection;

3. The centralizing tapered protrusion is disposed at the end of the first flange centralizing protrusion, and a centralizing tapered cylinder is disposed at the end of the second flange centralizing protrusion. The fitting of the centralizing tapered protrusion and the centralizing tapered cylinder enables the two flanged holes to be docked precisely;

4. By disposing the oil pipe support on the first centralizer, the first centralizer can be fixed to the oil pipe, facilitating centralization of docking of flanges in oil pipe connection, without having to continuously hold the first centralizer by hands:

5. The hydraulic cylinder enables the first centralizer and the second centralizer to be docked, allowing the two flanges to be precisely docked. The present invention can be used for docking of certain large flange installation holes, which could not be completed manually.

### BRIEF DESCRIPTION OF THE DRAWINGS

The figures described herein are used to provide a further understanding of the embodiments of the present invention and constitute a part of the present application but without limiting the embodiments of the present invention. In the figures:

FIG. 1 is a schematic diagram of the structure of the hydraulic adapter for installing connecting flanges of an oil pipe according to an embodiment of the present invention;

FIG. 2 is a schematic diagram showing the state of centralization and adjustment of two deviated flanges according to an embodiment of the present invention;

FIG. 3 is a schematic diagram showing the state after adjustment of two deviated flanges according to an embodiment of the present invention.

FIG. 4 is a schematic diagram of the structure of an oil pipe support according to an embodiment of the present invention; and

FIG. 5 is a schematic diagram of the structure of an adjusting bolt according to an embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

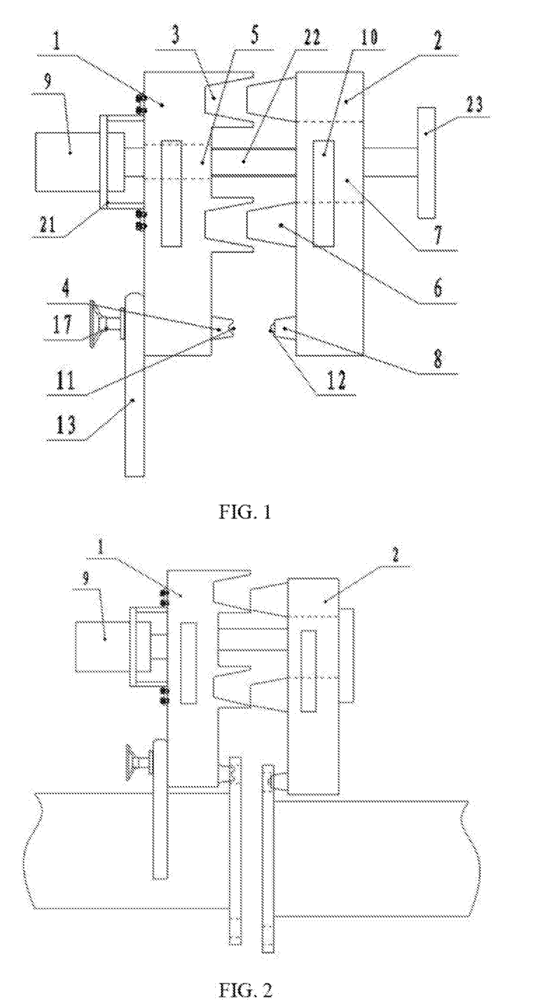

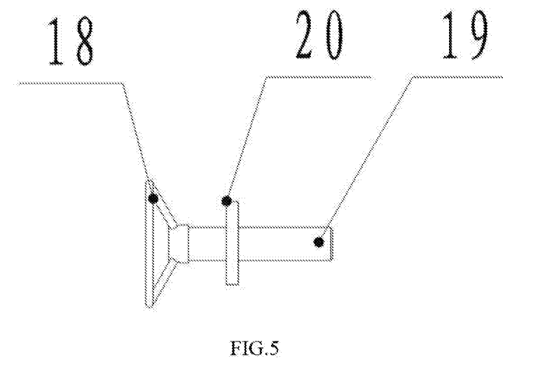

As shown in FIG. 1 to FIG. 4, a hydraulic adapter for installing connecting flanges of an oil pipe comprises a first centralizer 1, a second centralizer 2, and a hydraulic cylinder 9. Tapered cylinders 3 are respectively disposed on an upper portion and a middle portion of an inner side surface of the first centralizer 1. A first flange centralizing protrusion 4 is disposed on a lower portion of the inner side surface of the first centralizer 1. A hydraulic cylinder installation hole 5 is disposed on the first centralizer 1 between two of the tapered cylinders 3. Tapered protrusions 6 are respectively disposed on an upper portion and a middle portion of an inner side surface of the second centralizer 2 and fit with the tapered cylinders 3 disposed on the first centralizer 1. An adjustment hole 7 is disposed on the second centralizer 2 between two of the tapered protrusions 6. A second flange centralizing protrusion 8 is disposed on a lower portion of the inner side surface of the second centralizer 2. A base of the hydraulic cylinder 9 is disposed on an outer side of the first centralizer 1 by utilizing a hydraulic cylinder bracket 21, and a hydraulic arm 22 of the hydraulic cylinder perforates through the hydraulic cylinder installation hole 5 and the adjustment hole 7. An extrusion block 23 is disposed at an end of the hydraulic arm 22. The second centralizer 2 is returned to the first centralizer 1 by using the extrusion block 23. A hydraulic control station is connected to the hydraulic cylinder 9.

An oil pipe support 13 is disposed on the lower side of the outer side of the first centralizer 1 and comprises a control panel 14 and an arc shaped pipe rack 15. The control panel 14 is disposed on the arc shaped pipe rack 15. A bar adjustment hole 16 is disposed on the control panel 14, and the oil pipe support 13 are fixed on the first centralizer 1 by inserting an adjusting bolt 17 into the bar adjustment hole 16.

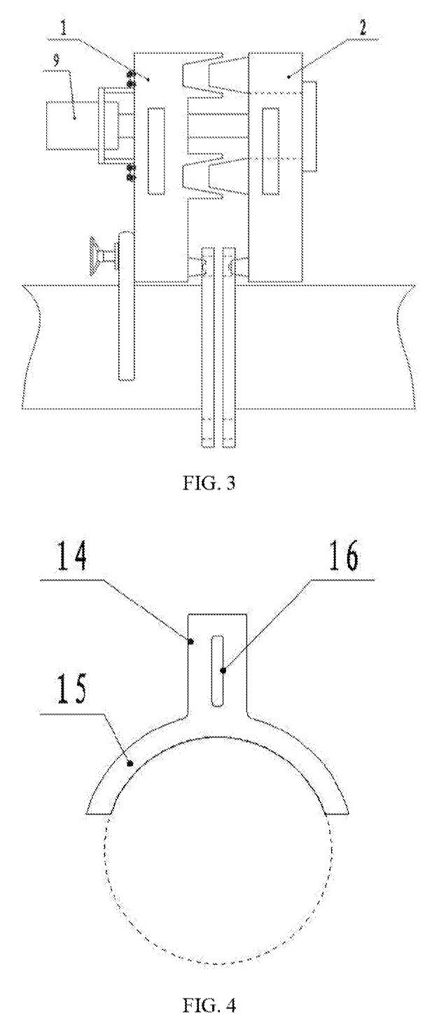

As shown in FIG. 2 to FIG. 3, to adjust the two deviated flanges, firstly, the centralizing hand wheel 18 is loosen allowing the second centralizer 2 is free to move on the screw 19. Thereafter, the first flange centralizing protrusion 4 of the first centralizer 1 is put into the installation hole of one of the flanges, and the adjusting bolt 17 is adjusted to enable the oil pipe support 13 to support the first centralizer 1. The first centralizer 1 is fixed to the oil pipe, the second flange centralizing protrusion 8 of the second centralizer 2 is then put into the pre-docking installation hole of another of the flanges. Thereafter, the hydraulic control station is started; the second centralizer 2 is moved toward the first centralizer 1 by using the hydraulic arm 22 of the hydraulic cylinder 9. Two of the tapered protrusions 6 of the second centralizer 2 fit with two of the tapered cylinders 3 of the first centralizer 1. When the docking of two of the tapered protrusions 6 and two of the tapered cylinders 3 is completed, the docking of flanges driven by the first flange centralizing protrusion 4 and the second flange centralizing protrusion 8 is ensured. After the docking is completed, the oil pipeline is supported, allowing the flange centralizing device to be removed. The bolt is installed on two flange connecting holes, and the docking is completed. The present invention is especially suitable for installation and docking of large flange holes.

By utilizing the fitting of the tapered cylinder 3 and tapered protrusion 6, the first flange centralizing protrusion 4 on the first centralizer 1 and the second flange centralizing protrusion 8 on the second centralizer 2 can be docked precisely, thus enabling the two deviated flanged holes to be fully docked and facilitating installation of the bolts.

As shown in FIG. 1 to FIG. 4, a hydraulic adapter for installing connecting flanges of an oil pipe according to another embodiment of the present invention is based on embodiment 1. A handle frame 10 is disposed on the first centralizer 1. A handle frame 10 is disposed on the second centralizer 2. The handle frames 10 on the first centralizer 1 and the second centralizer 2 facilitate centralization of docking of the flanges in oil pipe connection.

As shown in FIG. 1 to FIG. 4, a hydraulic adapter for installing connecting flanges of an oil pipe according to another embodiment of the present invention is based on embodiment 1. A centralizing tapered cylinder 11 is disposed at the end of the first flange centralizing protrusion 4, and a centralizing tapered protrusion 12 is disposed at the end of the second flange centralizing protrusion 8, and the centralizing tapered cylinder 11 fits with the centralizing tapered protrusion 12, which can enable the two flanged holes be docked precisely.

As shown in FIG. 1 to FIG. 3, a hydraulic adapter for installing connecting flanges of an oil pipe according to another embodiment of the present invention is based on embodiment 1. A centralizing tapered protrusion 12 is disposed at the end of the first flange centralizing protrusion 4, a centralizing tapered cylinder 11 is disposed at the end of the second flange centralizing protrusion 8, and the centralizing tapered cylinder 11 fits with the centralizing tapered protrusion 12, which enable the two flanged holes to be docked precisely.

As shown in FIG. 5, a hydraulic adapter for installing connecting flanges of an oil pipe according to another embodiment of the present invention is based on embodiment 1. The adjusting bolt 17 comprises an adjusting hand wheel 18, a screw 19 and a locking ring 20, and the adjusting hand wheel 18 is disposed on the end of the screw 19, and the locking ring 20 is fixed on the screw 19. Turning the adjusting hand wheel 18 can drive rotation of the screw 19. The screw locking ring 20 is disposed on the screw 19, allowing the oil pipeline to be stressed and locked, without having to install the screw 19 entirely in the first centralizer 1.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hydraulic adapter for installing connecting flanges of an oil pipe, comprising:
a first centralizer, wherein tapered cylinders are respectively disposed on an upper portion and a middle portion of an inner side surface of the first centralizer, a first flange centralizing protrusion is disposed on a lower portion of the inner side surface of the first centralizer, and a hydraulic cylinder installation hole is disposed on the first centralizer between two of the tapered cylinders;
a second centralizer, wherein tapered protrusions are respectively disposed on an upper portion and a middle portion of an inner side surface of the second centralizer and fit with the tapered cylinders disposed on the first centralizer, an adjustment hole is disposed on the second centralizer between two of the tapered protrusions, and a second flange centralizing protrusion is disposed on a lower portion of the inner side surface of the second centralizer; and
a hydraulic cylinder, wherein a base of the hydraulic cylinder is disposed on an outer side of the first centralizer by utilizing a hydraulic cylinder bracket, and a hydraulic arm of the hydraulic cylinder perforates through the hydraulic cylinder installation hole and the adjustment hole; and an extrusion block is disposed at an end of the hydraulic arm;
wherein an oil pipe support is disposed on a lower side of the outer side of the first centralizer and comprises a control panel and an arc shaped pipe rack, the control panel is disposed on the arc shaped pipe rack, wherein a bar adjustment hole is disposed on the control panel, and the oil pipe support are fixed on the first centralizer by inserting an adjusting bolt into the bar adjustment hole.

2. The hydraulic adapter according to claim 1, wherein a handle frame is disposed on the first centralizer.

3. The hydraulic adapter according to claim 1, wherein a handle frame is disposed on the second centralizer.

4. The hydraulic adapter according to claim 1, wherein a centralizing tapered cylinder is disposed at an end of the first flange centralizing protrusion, and a centralizing tapered protrusion is disposed at an end of the second flange centralizing protrusion, and the centralizing tapered cylinder fits with the centralizing tapered protrusion.

5. The hydraulic adapter according to claim 1, wherein a centralizing tapered protrusion is disposed at an end of the first flange centralizing protrusion, and a centralizing tapered cylinder is disposed at an end of the second flange centralizing protrusion, and the centralizing tapered cylinder fits with the centralizing tapered protrusion.

6. The hydraulic adapter according to claim 1, wherein the adjusting bolt comprises an adjusting hand wheel, a screw and a locking ring, and the adjusting hand wheel is disposed on an end of the screw, and the locking ring is fixed on the screw.
